(19) United States
(12) Patent Application Publication
(10) Pub. No.: US 2013/0083392 A1
(43) Pub. Date: Apr. 4, 2013

(54) MECHANISM FOR EMPLOYING AND FACILITATING A UNIVERSAL AND DYNAMIC EYEWEAR OPTICAL LENS STACK AND AN INTELLIGENT TRACKING SYSTEM AT AN EYEWEAR DEVICE

(71) Applicant: SUNIL K. JAIN, PORTLAND, OR (US)

(72) Inventor: SUNIL K. JAIN, PORTLAND, OR (US)

(21) Appl. No.: 13/251,055

(22) Filed: Sep. 30, 2011

(51) Int. Cl. G02B 27/26; G02B 27/22

(52) U.S. Cl. 359/465; 359/464

(57) ABSTRACT

A mechanism is described for facilitating a universal and dynamic eyewear optical lens. A method of embodiments of the invention includes monitoring wave patterns of waves being emitted from a first media device to a lens of an eyewear device, and detecting a change in the wave patterns. The wave pattern change may be caused when a new wave emitting from a second media device is detected. The method may further include dynamically adjusting the lens of the eyewear device to accept the new wave to facilitate viewing of contents being transmitted by the second media device.

### FIELD

The field relates generally to optics and, more particularly to electro-optics, employing a mechanism for facilitating a universal and dynamic eyewear optical lens at an eyewear device.

### BACKGROUND

A variety of Stereoscopic three-dimensional (3D) eyewear (e.g., 3D glasses) and their lack of interoperability are well-known. For example, for different types of 3D lenses are used for different media (e.g., televisions (TVs), movie screens, computer displays, etc.). Further, personal computer (PC) and consumer electronics (CE) devices use varying technologies, such as active shutter, active retarder, passive circular, linear or elliptical polarized, etc., and classically viewing angles of PC and monitor Liquid Crystal Display (LCD) screens have been 45/135 degree while for TV/CE displays have been 90 degree vertical. Today, these different technologies and/or viewing angles require different sets 3D glasses having various sets of technology/viewing angle-compatible lenses.

For example, currently, people use an active shutter 3D eyewear (e.g., 3DTV) for TV to watch a TV-based 3D movie, another active shutter 3D eyewear (e.g., 3DPC) to be used to watch something on a PC display, and yet another pair of eyewear of passive polarized glasses to watch passive or active retarder-based displays, etc. It is said that S3D eyewear are going through what is called “AC power brick syndrome” and it is expected that the world will soon be flooded with 3D eyewear for various different technologies, devices, and viewing angles, etc.

### BRIEF DESCRIPTION OF THE DRAWINGS

Embodiments of the present invention are illustrated by way of example and not by way of limitation in the figures of the accompanying drawings, in which like references indicate similar elements and in which:

FIG. 1 illustrates an eyewear lens having a lens stack according to one embodiment of the invention;

FIG. 2 illustrates a mechanism for facilitating a universal and dynamic eyewear according to one embodiment of the invention;

FIG. 3 illustrates a universal and dynamic eyewear according to one embodiment of the invention;

FIG. 4 illustrates a method for facilitating a universal and dynamic eyewear according to one embodiment of the invention;

FIG. 5 illustrates a computing system according to one embodiment of the invention;

FIG. 6 it illustrates a system for facilitating a universal and dynamic eyewear according to one embodiment of the invention; and

FIG. 7 illustrates a transactional sequence for facilitating a universal and dynamic eyewear according to one embodiment of the invention.

### DETAILED DESCRIPTION

Embodiments of the invention provide a mechanism for employing and facilitating a universal and dynamic eyewear optical lens. A method of embodiments of the invention includes monitoring wave patterns of waves being emitted from a first media device to a lens of an eyewear device, and detecting a change in the wave patterns. The wave pattern change may be caused when a new wave emitting from a second media device is detected. The method may further include dynamically adjusting the lens of the eyewear device to accept the new wave to facilitate viewing of contents being transmitted by the second media device.

Furthermore, a system or apparatus of embodiments of the invention may provide the mechanism and facilitate the aforementioned processes and other methods and processes described throughout the document. For example, in one embodiment, an apparatus of the embodiments of the invention may include a first logic to perform the aforementioned monitoring, a second logic to perform the aforementioned detecting, a third logic to perform the aforementioned dynamic adjusting, and the like, such as other or the same set of logic to perform other processes and methods described in this document.

A method of embodiments of the invention may further include detecting repeated wave patterns being emitted from a first media device to an eyewear device, including a 3D eyewear device, and synchronizing the eyewear electro-optical lens precisely to the changes in the wave patterns. The method may further include a special optical lens stack that adapts to a variety of optical polarization patterns typically present on a variety of transmitting media devices (e.g., 3D media devices). The method may further include dynamically adjusting the synchronization and polarization of the lens of the eyewear to accept and/or adapt to new wave patterns to facilitate viewing of contents being transmitted by a second media device with a second type of optical polarization that is different than the first media device. In one embodiment, this intelligent tracking of wave patterns works with the universal optical stack to provide the intended results as discussed throughout this document.

In one embodiment, a universal lens is introduced that provides interoperability of a 3D eyewear, resulting in eliminating multiple eyewear and instead, needing only a single eyewear for all media devices, technologies, viewing angles, etc. This universal lens, in one embodiment, is generated by adding a layer (e.g., quarter wave plate) to the layer stack and having an algorithm to facilitate the lens, including the additional layer, to perform universally, such as combining or be compatible with various technologies like circular polarizers, active shutter, passive shutter, etc. This novel lens may then be installed in any number of eyewear frames and be used, as aforementioned, when watching any number and types of media devices and such.

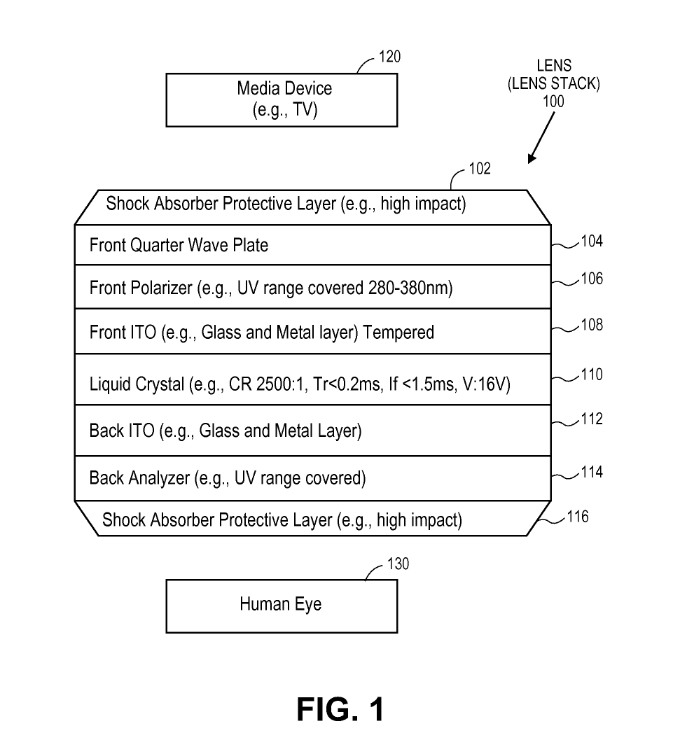

FIG. 1 illustrates an eyewear lens having a lens stack according to one embodiment of the invention. In one embodiment, lens 100 contains a high impact shock absorber protective layer 102 which is an outside layer that faces a media device (e.g., TV, computer, etc.). Similarly, another high impact shock absorber layer 116 is added to serve as the inside layer which is the first layer faced by a human eye 130. Other layers in the stack of lens 100 include a back analyzer 114 which covers the ultra-violate (UV) range and a front polarizer 106 that also covers the UV range, back and front ITOs 112, 108 that are glass and/or metal layers, and a liquid crystal layer 110. It is contemplated that the thickness and characteristics of each layer 102-116 in this optical stack of lens 100 can be changed for any number of reasons, such as per material availability, final thickness desired for lens 100, overall transmission and switching characteristics required, etc. For example, liquid crystal specifications of the liquid crystal layer 110 are shown here as an example and that depending on, for example, the contrast ratio (also known as extinction ratio) and the expected rise/fall time behavior, etc., the cell gap and switching voltage of the liquid crystal layer 110 can vary. Further, the shock absorbers 102, 116 may be used to determine how robust or unbreakable the lens 100 is expected to be and be bound by the national/local impact resistance standards of the country where the lens 100 is being manufactured. For example, in the United States of America, the lens 100 may be required to comply with Code of Federal Regulation's 21 CFR 801.410 Standard for impact resistance. Each of the polarizer layer 106 and the analyzer layer 114 may serve a dual purpose by filtering harmful UV per standards.

In one embodiment, a front quarter wave plate 104 is added to the optical stack to provide universality to lens 100. The quarter wave plate 104 (e.g., retarder) may include an optical device to alter the polarization state of a light wave travelling through it. Further, the quarter wave plate 104 may work by shifting the phase between two perpendicular polarization components of the light wave. In one embodiment, the quarter wave plate 104 works with a microprocessor installed on the eyewear employing the lens 100 to detect, for example, media devices and varying technologies to universally adjust the lens 100 according to the changing media devices and technologies, etc. Further, any linearly polarized light which strikes the quarter wave plate 104 is divided into multiple components with various indices of refraction, such as converting linearly polarized light to circularly polarized light and vice versa upon detecting the changing media device. The detection may be performed using various sensors and at least one microprocessor employed by the eyewear.

In one embodiment, the quarter wave plate 104 may work with liquid crystal layer 110 to determine the type of media device and the technology being used by the media device. For example, when the lens 100 is in active mode, the liquid crystal layer 110 may be active, while the quarter wave plate 104 may sleep. In contrast, when the liquid crystal layer 110 is inactive, the wave plate 104 searches for 3D and performs its tasks. Finally, the two layers 104, 110 may work together to perform other tasks, such as working with holographic images.

In one embodiment, a number of sensors (e.g., infrared sensors, photo sensors, electrical sensors, etc.) may be employed on the eyewear to sense (e.g., sniff) the waves to detect a wave pattern and any changes to the wave pattern. Upon detecting a change in the wave pattern, that change is communicated to the processor from where it is communicated to the lens stack of the lens 100. For example, if the wave pattern has changed from a computer screen to a large movie screen, the change is the ultimately communicated to the lens stack of the lens 100 so that the wave plate 104 and liquid crystal layer 110 can accordingly adjust the lens 100. Examples of currently available 3D glasses include Sony® 3D Tdg-br100 glasses, LG® Cinema 3D glasses, Samsung® SSG-3100GB 3D Active glasses, etc.

In one embodiment, an intelligent tracking system for wave pattern tracking is employed and facilitated with the universal lens stack 100 for tracking repeated or repeating wave patterns being emitted from a first media device (e.g., television screen), such as media device 120, to a 3D eyewear are detected, and the 3D eyewear electro-optical lens 100 is synchronized precisely to the detected changes in the wave patterns. Further, a special optical lens stack, such as lens stack 100, is provided that adapts to a variety of optical polarization patterns typically present on a variety of transmitting 3D media devices. In one embodiment, synchronization and polarization of the lens 100 of the 3D eyewear is dynamically adjusted to accept and/or adapt to new or newly detected repeated wave patterns to facilitate viewing of contents being transmitted by a second media device (e.g., cinema screen) with a second type of optical polarization that is different than the first media device 120.

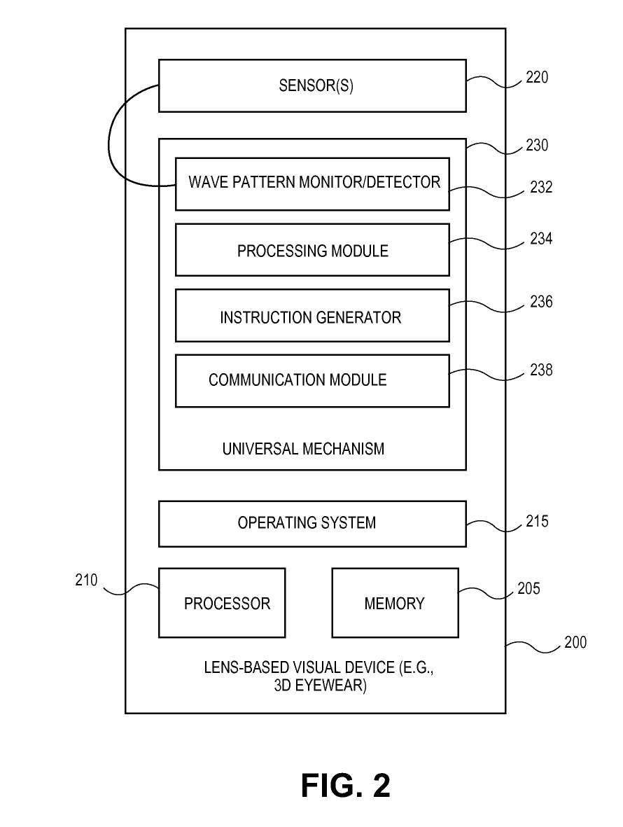

FIG. 2 illustrates a mechanism for facilitating a universal and dynamic eyewear according to one embodiment of the invention. In one embodiment, eyewear 200 represent a device having one or more lens, such as lens 100, one or more sensors (e.g., infrared sensors, photo sensors, electric sensors, etc.), and a mechanism for facilitating a universal eyewear (“universal mechanism”) 230. The device or eyewear 200 further includes an operating system 215 serving as an interface between any hardware or physical resources of the eyewear 200 and a user. The eyewear 200 may further include a processor 210, memory devices 205, or the like.

In one embodiment, universal mechanism 230 includes a number of components (e.g., software modules), such as a wave pattern monitor/detector 232 working with one or more sensors 220 to monitor the air for waves (e.g., photo waves, audio and/or video waves, electromechanical waves, etc.) and their pattern. While monitoring, the monitor/detector 232 may detect a change in the wave pattern. Such a change is then processed and analyzed by a processing module 234. Based on the processing and analysis of the change, a set of instructions may be generated by an instruction generator 236. These instructions are then communicated, using a communication module 238, to a lens stack of the lens of the eyewear 200 to dynamically adjust according to the change and universally accept the wave to provide the user a universal, seamless, and continues use of the eyewear 200 despite the change (e.g., media device change, technology change, viewing angle change, etc.).

In one embodiment, the universal mechanism 230 facilitates the universal lens stack of FIG. 1 to work with this intelligent tracking system provided by various components 232-238 of the universal mechanism 230 to, for example, using the wave pattern monitor/detector 232 to track repeated or repeating wave patterns being emitted from a first media device to a 3D eyewear 200 are detected, and the 3D eyewear electro-optical lens is synchronized precisely to the detected changes in the wave patterns. Further, a special optical lens stack (e.g., universal lens stack of FIG. 1) is provided that adapts to a variety of optical polarization patterns typically present on a variety of transmitting 3D media devices. In one embodiment, synchronization and polarization of the lens of the 3D eyewear 200 is dynamically adjusted to accept and/or adapt to new or newly detected repeated wave patterns to facilitate viewing of contents being transmitted by a second media device with a second type of optical polarization that is different than the first media device.

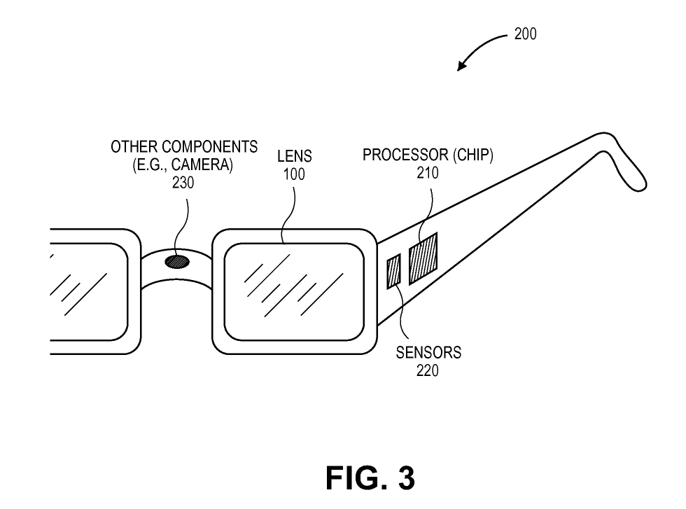

FIG. 3 illustrates a universal and dynamic eyewear according to one embodiment of the invention. In one embodiment, the eyewear 200 includes a lens 100 that includes the lens stack as described with reference to FIG. 1. For example, in one embodiment, the lens 100 includes a quarter wave plate which works with other layers (e.g., liquid crystal layer) of the lens stack of lens 100 to adjust the lens according to the changing media screens, technologies, viewing angles, and the like.

In one embodiment, as aforementioned with reference to FIG. 2, the eyewear 200 may further include one or more sensors 220 (e.g., infrared sensor, photo sensors, electrical sensors, etc.) to sense the changing media screens, technologies, viewing angels, etc., by detecting wave patterns by sniffing the waves being carried between media devices and the eyewear 200 and other eyewear. Once a change in the wave pattern is detected by one or more sensor 220, that change in the wave pattern communicated to a processor 210. Upon receiving information about the wave pattern change, the processor 210, using the universal mechanism as referenced with respect to FIG. 2, may evaluate and process that information and provide appropriate instructions to the lens 100. For example, a user in a shopping mall watches a small TV screen using the eyewear 200. Then, the user goes into a movie theater within the mall and now, watches a big movie screen. The sensors 220 continue to sniff or detect the waves and wave patterns and when the user turns to the big movie screen, one or more sensors 220 can detect the change in the wave pattern and reports to the processor 210. Using the universal mechanism, the processor 210 processes the information received from the sensors 220. Upon processing the information, the processor 210 provides appropriate instructions to the lens 100, such as an instruction to switch its quart wave plate to work with its liquid crystal layer to switch the lens' reception from the small TV screen to the big movie screen. Similarly, working with the universal mechanism, the sensors 220, the processor 210, and the various layers of the lens stack of the lens 100 continue to work with the changing wave patterns to provide and maintain the novel universality of the eyewear 200.

In one embodiment, the eyewear 200 may further include other components 230, such as a camera, an audio recording device, additional sensors, etc., to capture pictures, record audio, generate holographic images, and the like. Embodiments of the invention are not limited to the eyewear 200 illustrated here and that any number of features can be added or removed from the eyewear 200 to continually maintain universality and staying compatible with changing technologies.

In one embodiment, repeated or repeating wave patterns being emitted from a first media device to a 3D eyewear 200 are detected, and the 3D eyewear electro-optical lens 100 is synchronized precisely to the detected changes in the wave patterns. Further, a special optical lens stack is provided that adapts to a variety of optical polarization patterns typically present on a variety of transmitting 3D media devices. In one embodiment, synchronization and polarization of the lens 100 of the 3D eyewear 200 is dynamically adjusted to accept and/or adapt to new or newly detected repeated wave patterns to facilitate viewing of contents being transmitted by a second media device with a second type of optical polarization that is different than the first media device.

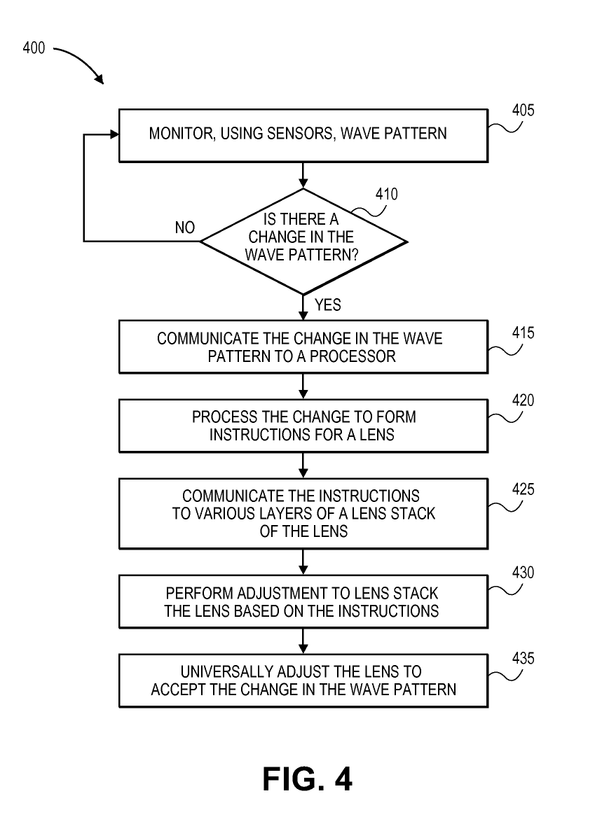

FIG. 4 illustrates a method for facilitating a universal and dynamic eyewear according to one embodiment of the invention. Method 400 may be performed by processing logic that may comprise hardware (e.g., circuitry, dedicated logic, programmable logic, etc.), software (such as instructions run on a processing device), or a combination thereof. In one embodiment, method 400 is performed by the universal mechanism of FIG. 2 in communication with the lens 100, the processor 210, the sensors 220, etc., of FIGS. 1-3.

Method 400 starts at block 405 with one or more sensors (e.g., infrared sensors, photo sensors, electrical sensors, etc.) employed on an eyewear sensing or monitoring the air for waves and wave patterns. The waves may include photo waves, infrared waves, audio and/or video waves, etc., being communicated to or from one or more media devices (e.g., TVs, computer devices, movie screens) that are to be seen on the screens of the media devices. At block 410, a determination is made as to whether one or more sensors have detected a change in the wave pattern. If a wave pattern change is not detected, the process continues with monitoring of the wave patterns at block 405. If, however, a change in wave pattern is detected, the change and related information is communicated to the processor at block 415.

The change is processed by the process at block 420. In processing the change, the processor generates one or more instructions. The instructions are then communicated to various layers of lens stack of the lens of the eyewear at block 425. The instructions received at the lens stack are processed by the various layers, such as a quarter wave plate or a liquid crystal layer, etc., to adjust according to the change in the wave pattern at block 430. The change in the wave pattern may relate to a user having the eyewear going from a room having a computer device to a room with a TV to a room with a movie screen, etc. At block 435, the lens stack is dynamically adjusted to the change in the wave pattern to universally ready the lens of the eyewear to the new form of wave pattern which may be due to a detecting another media device, video technology, viewing angle, or the like.

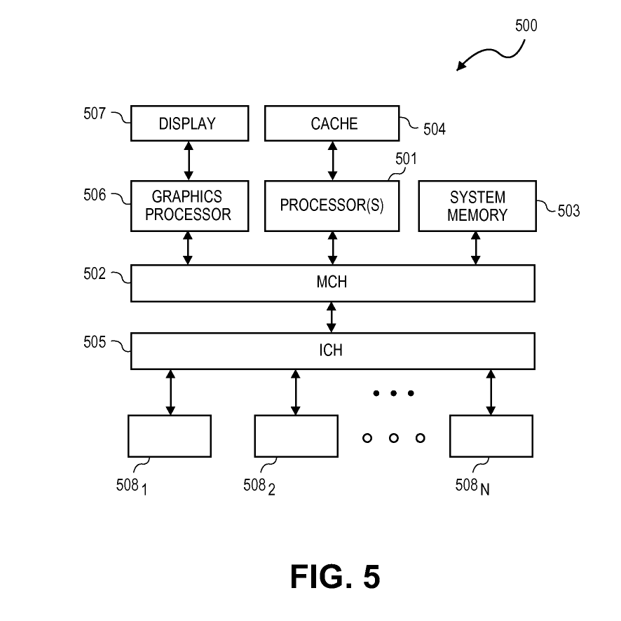

FIG. 5 illustrates a computing system 500 representing a device (e.g., eyewear 200 of FIG. 3) capable of employing universal mechanism 230 as referenced in FIG. 2 according to one embodiment of the invention. The exemplary computing system of FIG. 5 includes: 1) one or more processor 501 at least one of which may include features described above; 2) a memory control hub (MCH) 502; 3) a system memory 503 (of which different types exist such as double data rate RAM (DDR RAM), extended data output RAM (EDO RAM) etc.); 4) a cache 504; 5) an input/output (I/O) control hub (ICH) 505; 6) a graphics processor 506; 7) a display/screen 507 (of which different types exist such as Cathode Ray Tube (CRT), Thin Film Transistor (TFT), Liquid Crystal Display (LCD), DPL, etc.; and 8) one or more I/O devices 508.

The one or more processors 501 execute instructions in order to perform whatever software routines the computing system implements. The instructions frequently involve some sort of operation performed upon data. Both data and instructions are stored in system memory 503 and cache 504. Cache 504 is typically designed to have shorter latency times than system memory 503. For example, cache 504 might be integrated onto the same silicon chip(s) as the processor(s) and/or constructed with faster static RAM (SRAM) cells whilst system memory 503 might be constructed with slower dynamic RAM (DRAM) cells. By tending to store more frequently used instructions and data in the cache 504 as opposed to the system memory 503, the overall performance efficiency of the computing system improves.

System memory 503 is deliberately made available to other components within the computing system. For example, the data received from various interfaces to the computing system (e.g., keyboard and mouse, printer port, Local Area Network (LAN) port, modem port, etc.) or retrieved from an internal storage element of the computer system (e.g., hard disk drive) are often temporarily queued into system memory 503 prior to their being operated upon by the one or more processor(s) 501 in the implementation of a software program. Similarly, data that a software program determines should be sent from the computing system to an outside entity through one of the computing system interfaces, or stored into an internal storage element, is often temporarily queued in system memory 503 prior to its being transmitted or stored.

The ICH 505 is responsible for ensuring that such data is properly passed between the system memory 503 and its appropriate corresponding computing system interface (and internal storage device if the computing system is so designed). The MCH 502 is responsible for managing the various contending requests for system memory 503 accesses amongst the processor(s) 501, interfaces and internal storage elements that may proximately arise in time with respect to one another.

One or more I/O devices 508 are also implemented in a typical computing system. I/O devices generally are responsible for transferring data to and/or from the computing system (e.g., a networking adapter); or, for large scale non-volatile storage within the computing system (e.g., hard disk drive). ICH 505 has bi-directional point-to-point links between itself and the observed I/O devices 508.

Portions of various embodiments of the present invention may be provided as a computer program product, which may include a computer-readable medium having stored thereon computer program instructions, which may be used to program a computer (or other electronic devices) to perform a process according to the embodiments of the present invention. The machine-readable medium may include, but is not limited to, floppy diskettes, optical disks, compact disk read-only memory (CD-ROM), and magneto-optical disks, ROM, RAM, erasable programmable read-only memory (EPROM), electrically EPROM (EEPROM), magnet or optical cards, flash memory, or other type of media/machine-readable medium suitable for storing electronic instructions.

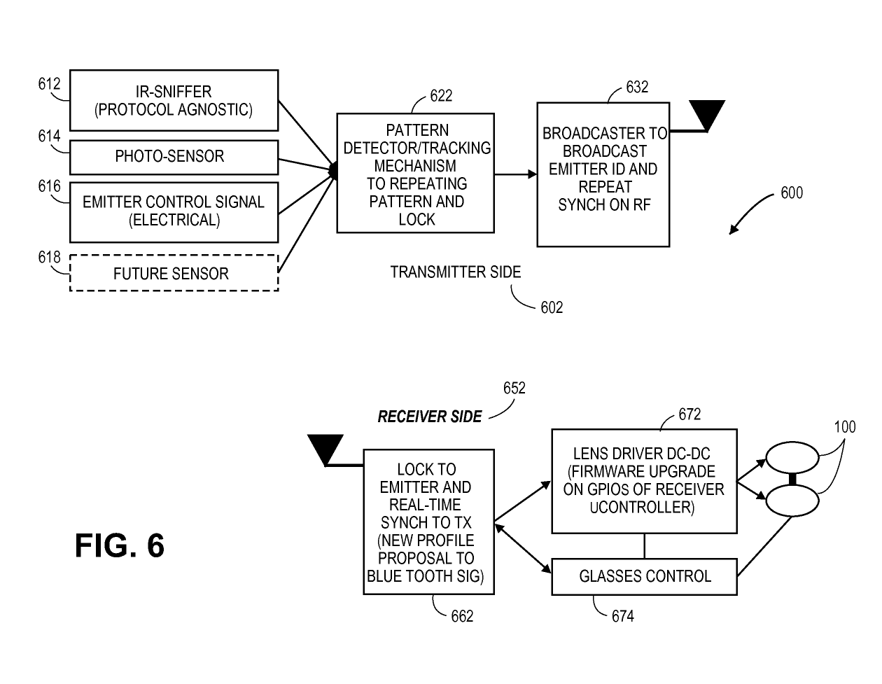

Now referring to FIG. 6, it illustrates a system 600 for facilitating a universal and dynamic eyewear according to one embodiment of the invention. System 100 is provided through a lens-based visual device, such as the visual device 200 having the universal mechanism 230 of FIG. 2. System 100 illustrates a transmitting side 602 of the visual device to provide an IR-sniffer (e.g., protocol agnostic) to sniff or detect the type of media waves (e.g., 3D media waves, other media waves, etc.) being provided by a media device, such as media device (e.g., television) 120 of FIG. 1. The transmitting side 602 further includes a photo sensor 614 that is part of sensors 220 of FIG. 2 to sense the wave lights of the media waves beings provided by the media device. A control signal emitter (electrical) 616 to emit control signals relevant to the media waves, while a future sensor 618 (also of sensors 220) may be used to predict or detect future patterns or types of the media waves. Using a combination of the IR-sniffer 612, the photo sensor 614, the control signal emitter 616, and the future sensor 618, a repeated patter of the media waves is detected and then locked by a wave pattern detector and locking mechanism 622 which may be the same as or part of wave pattern monitor/detector 232 of FIG. 2. A broadcaster 632 is then used to broadcast an emitter identification (ID) and repeat synchronization on radio frequency (RF). The broadcaster 632 may be part of the wave pattern monitor/detector 232 and the communication module 238 of FIG. 2.

A locking and synchronization mechanism 662 on the receiver side 652 may then lock the media wave patter based on the emitter ID and perform real-time synchronization with the transmitter side 602. The locking and synchronization mechanism 662 may be part of the universal mechanism 230 and more particularly of one or more of its components 232-238. A lens driver 672 and glasses control 674 communicate the relevant information (e.g., media wave pattern, emission ID, etc.) to the lenses 100 (so they may perform their task, such as adjust to receive 3D wave patterns from a media device) of the lens-based visual device, such as the visual device 200 (e.g., 3D glasses) of FIG. 2.

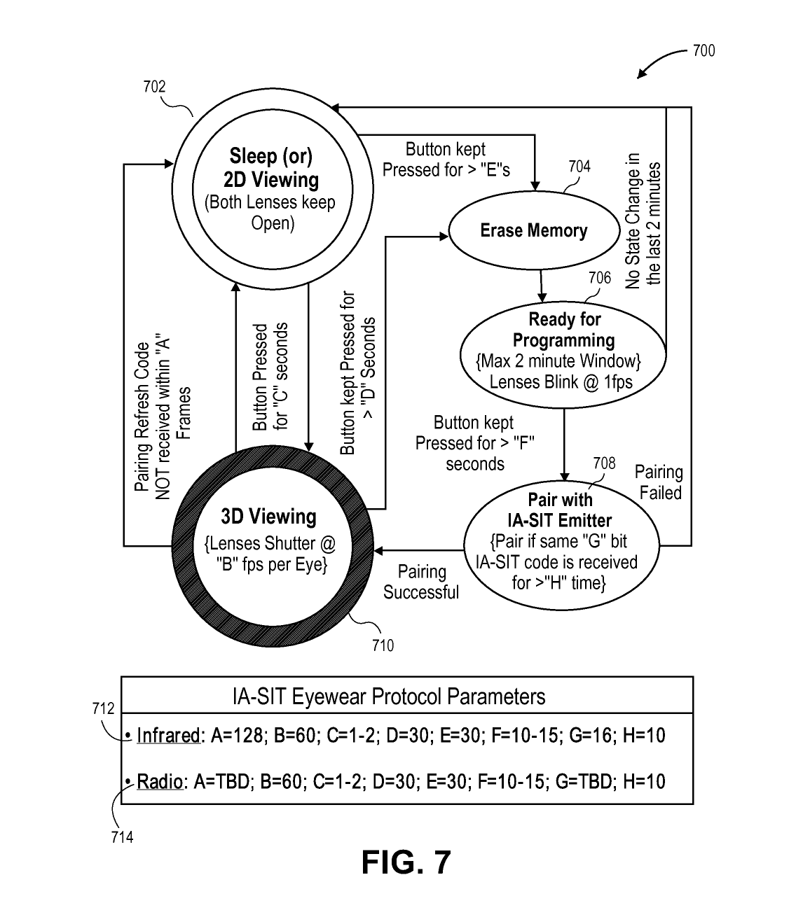

FIG. 7 illustrates a transactional sequence 700 for facilitating a universal and dynamic eyewear according to one embodiment of the invention. In one embodiment, the lenses of a lens-based visual device (e.g., 3D glasses) may be in sleep-mode 702, such as set to view in 2D or simply stay asleep. When a button on the glasses is pressed for a certain number of time or for a particular length of time, the lenses may erase the memory 704 (anticipating or detecting a new pattern of media wave, such as a 3D wave). Once or while the memory is erased 704, the lenses of the 3D glasses get ready for programming (or re-programming) 706 to get ready to receive the newly-detected media wave pattern. Then, pairing with IA-SIT emitter is attempted 708. IA-SIT refers to eyewear protocol parameters, such as the illustrated infrared parameters 712 and radio parameters 714. If the IA-SIT emitter pairing fails, the process returns to the lenses continuing to stay asleep or simply view in 2D. If, however, the IA-SIT emitter pairing is successful, the lenses get transformed (or adjusted), as described throughout this document, into 3-D vising lenses 710 capable of viewing the new 3D-based media wave pattern. In one embodiment, the one or more processes 702-710 of the transaction sequence 700 are facilitated by the universal mechanism 230 and other relevant components as described with reference to the preceding figures.

The techniques shown in the figures can be implemented using code and data stored and executed on one or more electronic devices (e.g., an end station, a network element). Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals—such as carrier waves, infrared signals, digital signals). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). Thus, the storage device of a given electronic device typically stores code and/or data for execution on the set of one or more processors of that electronic device. Of course, one or more parts of an embodiment of the invention may be implemented using different combinations of software, firmware, and/or hardware.

In the foregoing specification, the invention has been described with reference to specific exemplary embodiments thereof. It will, however, be evident that various modifications and changes may be made thereto without departing from the broader spirit and scope of the invention as set forth in the appended claims. The Specification and drawings are, accordingly, to be regarded in an illustrative rather than a restrictive sense.

I claim:

1. A computer-implemented method comprising:
monitoring wave patterns of waves being emitted from a first media device to a lens of an eyewear device;
detecting a change in the wave patterns, wherein the wave pattern change is caused when a new wave emitting from a second media device is detected;
dynamically adjusting the lens of the eyewear device to accept the new wave to facilitate viewing of contents being transmitted by the second media device.

2. The computer-implemented method of claim 1, further comprising processing information relating to the wave pattern change to generate one or more instructions, and wherein the eyewear device includes a three-dimensional (3D) eyewear device.

3. The computer-implemented method of claim 2, further comprising communicating the one or more instructions to a lens stack of the lens, wherein the dynamic adjustment is performed based on the one or more instructions.

4. The computer-implemented method of claim 1, wherein the first and second media devices comprise one or more of a television, a computing device display, and a movie screen.

5. The computer-implemented method of claim 3, wherein the lens stack comprises a front quarter wave plate.

6. The computer-implemented method of claim 5, wherein the lens stack further comprises layers including one or more of front and back shock observer protective layers, front and back polarizers, front and back glass and metal layers, and a liquid crystal layer.

7. A system comprising:
an eyewear device having a lens, a memory to store instructions, and a processing device to execute the instructions, wherein the instructions cause the processing device to:
monitor wave patterns of waves being emitted from a first media device to the lens of the eyewear device;
detect a change in the wave patterns, wherein the wave pattern change is caused when a new wave emitting from a second media device is detected;
dynamically adjust the lens of the eyewear device to accept the new wave to facilitate viewing of contents being transmitted by the second media device.

8. The system of claim 7, wherein the processing device is further to process information relating to the wave pattern change to generate one or more instructions, and wherein the eyewear device includes a three-dimensional (3D) eyewear device.

9. The system of claim 8, wherein the processing device is further to communicate the one or more instructions to a lens stack of the lens, and to perform the dynamic adjustment based on the one or more instructions.

10. The system of claim 7, wherein the first and second media devices comprise one or more of a television, a computing device display, and a movie screen.

11. The system of claim 9, wherein the lens stack comprises a front quarter wave plate.

12. The system of claim 11, wherein the lens stack further comprises layers including one or more of front and back shock observer protective layers, front and back polarizers, front and back glass and metal layers, and a liquid crystal layer.

13. A machine-readable medium including instructions that, when executed by a machine, cause the machine to:
monitoring wave patterns of waves being emitted from a first media device to a lens of an eyewear device;
detecting a change in the wave patterns, wherein the wave pattern change is caused when a new wave emitting from a second media device is detected;
dynamically adjusting the lens of the eyewear device to accept the new wave to facilitate viewing of contents being transmitted by the second media device.

14. The machine-readable medium of claim 13, further comprises one or more instructions that, when executed by the machine, further cause the machine to process information relating to the wave pattern change to generate one or more instructions, and wherein the eyewear device includes a three-dimensional (3D) eyewear device.

15. The machine-readable medium of claim 14, further comprises one or more instructions that, when executed by the machine, further cause the machine to communicate the one or more instructions to a lens stack of the lens, and perform the dynamic adjustment based on the one or more instructions.

16. The machine-readable medium of claim 13, wherein the first and second media devices comprise one or more of a television, a computing device display, and a movie screen.

17. The machine-readable medium of claim 15, wherein the lens stack comprises a front quarter wave plate.

18. The machine-readable medium of claim 17, wherein the lens stack further comprises layers including one or more of front and back shock observer protective layers, front and back polarizers, front and back glass and metal layers, and a liquid crystal layer.

19. An apparatus comprising:
first logic to monitor wave patterns of waves being emitted from a first media device to a lens of an eyewear device;
second logic to detect a change in the wave patterns, wherein the wave pattern change is caused when a new wave emitting from a second media device is detected;
third logic to dynamically adjust the lens of the eyewear device to accept the new wave to facilitate viewing of contents being transmitted by the second media device.

20. The apparatus of claim 19, further comprising forth logic to process information relating to the wave pattern change to generate one or more instructions, and wherein the eyewear device includes a three-dimensional (3D) eyewear device.

21. The apparatus of claim 20, further comprising fifth logic to communicate the one or more instructions to a lens stack of the lens, and perform the dynamic adjustment based on the one or more instructions.

22. The apparatus of claim 19, wherein the first and second media devices comprise one or more of a television, a computing device display, and a movie screen.

23. The apparatus of claim 21, wherein the lens stack comprises a front quarter wave plate.

24. The apparatus of claim 23, wherein the lens stack further comprises layers including one or more of front and back shock observer protective layers, front and back polarizers, front and back glass and metal layers, and a liquid crystal layer.
